(19) United States
(12) Patent Application Publication
(10) Pub. No.: US 2003/0025754 A1
(43) Pub. Date: Feb. 6, 2003

(54) CHIP STRUCTURE IN INK-JET HEAD

(75) Inventors: Tse-Chi Michael Mou, Hsinchu (TW); Fu-San Lin, Hsinchu (TW); Chin-Yi Chou, Hsinchu (TW); Ying-Lun Chang, Hsinchu (TW); Cheng-Hung Yu, Hsinchu (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Microjet Technology Co., Ltd., Hsinchu (TW)

(21) Appl. No.: 09/922,586

(22) Filed: Aug. 3, 2001

(51) Int. Cl. B41J 2/015

(52) U.S. Cl. 347/20

(57) ABSTRACT

A chip structure in an ink-jet head including plural ink feed openings arranged in a longitudinal direction and a method for fabricating the chip structure are disclosed. The structure of plural ink feed openings increases the structure strength of the chip in order to resist the stress during the procedure for preventing the chip from breaking, and increasing the ink supplying rate.

### FIELD OF THE INVENTION

The present invention relates to a chip structure in an ink-jet head, and more particularly to an ink feed opening structure of a chip in an ink-jet head. The present invention also relates to a method for fabricating an ink feed opening structure of a chip in an inkjet head.

### BACKGROUND OF THE INVENTION

For the early ink-jet printer, because the printing speed is slow and the resolution is low, one resistor heater element is corresponded to one ink feed opening on a chip. However, along the resolution and the printing speed increasing, the number of the resistor heater element on the chip is largely increased. Furthermore, for increasing the area covering the scanned paper during printing, the resistor heater elements are generally arranged at two sides of the ink feed opening. Typically, the ink feed opening 16 is a long slot for supplying enough ink to each resistor heater element 15. Therefore, one ink feed opening 16 is corresponded to plural resistor heater elements 15 as shown in FIG. 1. In addition, U.S. Pat. No. 4,680,856 also discloses that an ink feed opening 16 of a chip 10 is a long slot as shown in FIG. 2.

Currently, the ink feed opening 16 of the chip 10 is formed by a single process. That is, the narrow-long through hole is formed in the chip 10 by high pressure gas carrying with sand in few seconds. Furthermore, the length of the ink feed opening 16 is always over 70% of the chip in length, even almost reach the length of chip 10. Thus, during the sand spray process, some slight breaks will occur around the ink feed opening 16 because the area 11 of the chip 10 for standing the impact force from the high pressure sand material is too small and the stress on the area 11 of the chip 10 is too big. Hence, the chip 10 is easy crashed, which results in the production loss. In addition, because the chip 10 is processed on a wafer and then cut and the sand spray process is proceeded on the broken surface in the wafer microstructure, the too long opening for ink feeding 16 is easy broken. Even though the chip is not broken during sand spray process, the chip including the residual stress is still easily broken at the follow-up processes such as thermal cycle, gluing, solidifying, and shrinking. Further, the chip is also easily broken when the high current passes through the chip, the impact force from the ink is applied on the chip, or other non-expected force is applied on the chip during printing, which results in ink leakage.

Therefore, the purpose of the present invention is to develop a structure and a method to deal with the above situations encountered in the prior art.

### SUMMARY OF THE INVENTION

It is therefore an object of the present invention to provide a chip structure in an ink-jet head and a method for fabricating the chip structure. During fabricating process, plural ink feed openings are formed on the chip. The chip structure and the method according to the present invention has the following advantages:

1. The chip structure fabricated by the method of the present invention is more resistant to the impact and the stress during fabricating process, so the broken rate of the chip can be reduced.

2. Because the chip includes the non-opened region located between plural ink feed openings, the strength of the chip increases and is able to resist to the possible damage caused by the stress change in the follow-up procedure and to prevent the stress from transferring.

3. The chip structure of the present invention can efficiently supply ink to each resistor heater element.

Therefore, comparing to the prior art, the chip structure and the method for fabricating plural ink feed openings on the chip in an ink-jet head can increase yield and reliability of the product.

A chip structure according to the present invention includes plural ink feed openings arranged in a longitudinal direction and is a portion of an ink-jet head. The ink-jet head includes a base, a chip, a circuit board and an orifice plate. The base can be a plastic body and includes a slot and a preset position for disposing the chip thereon. The circuit board is used for connecting a resistor heater element of the chip to an external circuit. In addition, the orifice plate is disposed on the chip, and the chip including a plurality of ink feed openings arranged in a longitudinal direction, wherein the plural ink feed openings of the chip are corresponded to the slot of the base for supplying the ink from the slot of the base to the plural ink feed openings of the chip. The slot of the base can be an elongated slot whose area can cover the area of the plural ink feed openings of the chip. Both the ink feed opening and the slot have an edge which is arc-shaped and a shape of rectangle, ellipse, elongated ellipse, or two elongated ellipses collaterally combined to each other.

The present invention also provides a method for fabricating a plurality of ink feed openings of a chip in an ink-jet head. The method includes steps of (1) forming an alignment mark on the chip, (2) inputting a parameter into an image identification system in a processing machine, (3) proceeding an image identification of the alignment mark on the chip according to the parameter to confirm a predetermined position of each the ink feed opening, and (4) forming the plural ink feed openings of the chip by mechanical processing.

Further, during fabricating a wafer, the alignment marks are predetermined for accurately aligning in an extremely tiny error range. The shape of alignment mark can be circle, square, triangle, or other geometric figures. The image identification system can include an electric charge coupling device (CCD), a servo-motor and a software. Furthermore, the parameters are input into the image identification system of a processing machine and the image identification system is operated by a preset procedure of identifying the alignment mark, the relative position of each ink feed opening, and the processing sequence. That is, after the image identification system of a fine sand spraying machine or a laser processing machine will proceed an image identification of the alignment marks on the chip by the predetermined parameters, the ink feed openings are formed by the processing machine.

The present invention may best be understood through the following description with reference to the accompanying drawings, in which:

### BRIEF DESCRIPTION OF THE DRAWINGS

FIG. 1 is a diagram illustrating an ink feed opening structure of a chip in an ink-jet head according to the prior art;

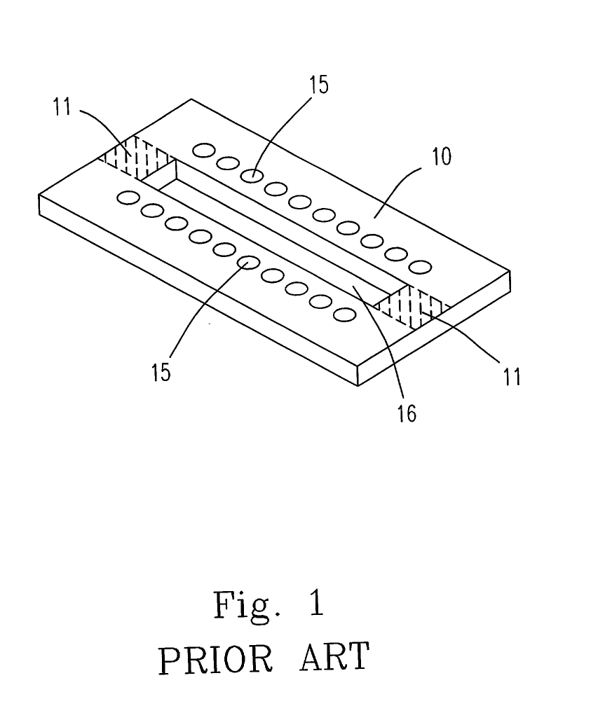

FIG. 2 is a diagram illustrating a chip structure of an ink-jet head shown in U.S. Pat. No. 4,680,859;

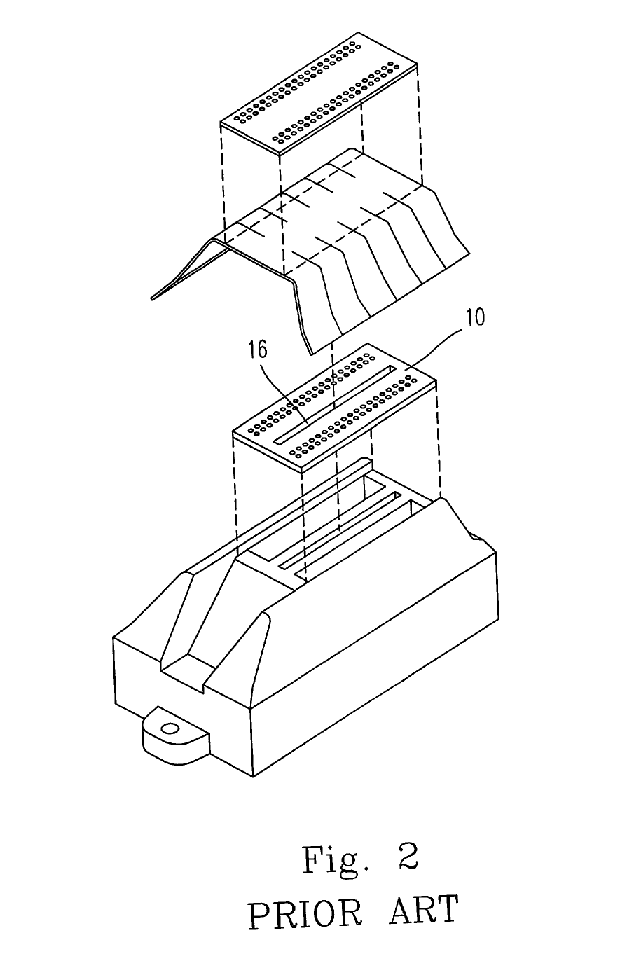

FIG. 3 is a diagram illustrating a preferred embodiment of an ink feed opening structure of a chip in an ink-jet head according to the present invention;

FIG. 4 is a diagram illustrating another preferred embodiment of an ink feed opening structure of a chip in an ink-jet head according to the present invention;

FIG. 5 is a diagram illustrating a preferred embodiment of alignment marks on a chip according to the present invention; and

FIG. 6 is a decomposition view illustrating a preferred embodiment of a chip and a base of an ink-jet head according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

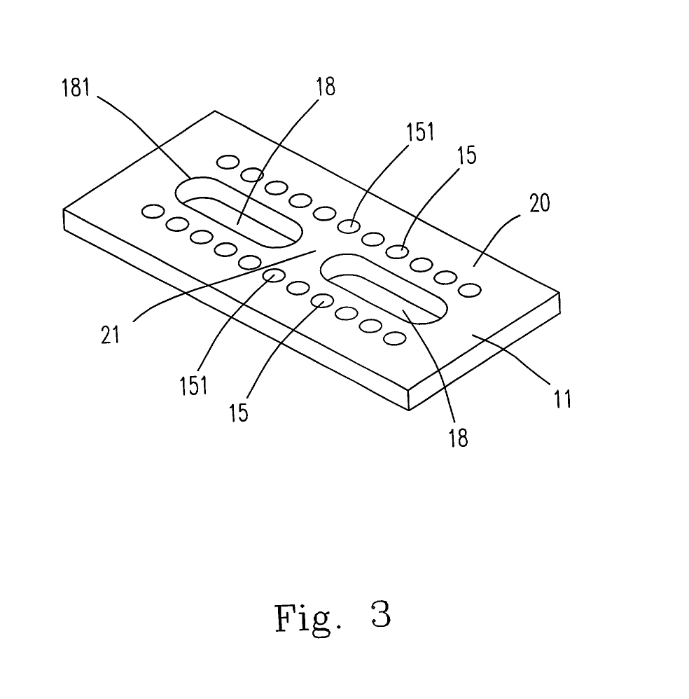

FIG. 3 is a diagram illustrating a preferred embodiment of an ink feed opening structure of a chip in an ink-jet head according to the present invention. As shown in FIG. 3, a chip 20 in an ink-jet head includes two ink feed openings 18 arranged in a longitudinal direction and plural resistor heater elements 15 arranged at two sides of the ink feed openings 18. A bridge 21 is located between two ink feed openings 18. The ink feed openings 18 can evenly supply the ink to each resistor heater element 15, even a resistor heater element 151 which locates at two sides of bridge 21. In addition, for preventing the stress centralization from a corner of the ink feed opening 18, the corner is processed to become an arc-shaped corner 181. That is, the shape of ink feed opening 18 is an elongated ellipse. Thus, the leakage in the ink-jet head resulting from the crash caused by the stress centralization in the corner of the ink feed opening 18 will be avoided.

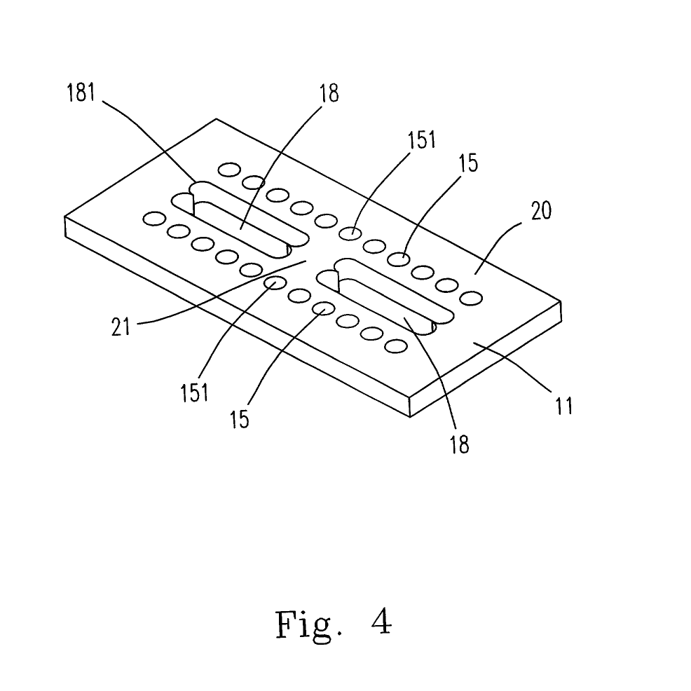

FIG. 4 is a diagram illustrating another preferred embodiment of an ink feed opening structure of a chip in an ink-jet head according to the present invention. The structure of the chip 20 is similar to that of the above embodiment except that the ink feed opening 18 is a shape of two elongated ellipses collaterally combined to each other as shown in FIG. 4.

The bridge 21 in the chip 20 can increase a cross sectional area in the longitudinal direction for decreasing the stress effect on the chip 20. Thus, during the follow-up step, the chip 20 resists to the hot or cool reactions and does not crash for increasing yield. In addition, the number of the ink feed opening 18 is dependent on the size of the chip 20, so the number of the ink feed opening can be two or more.

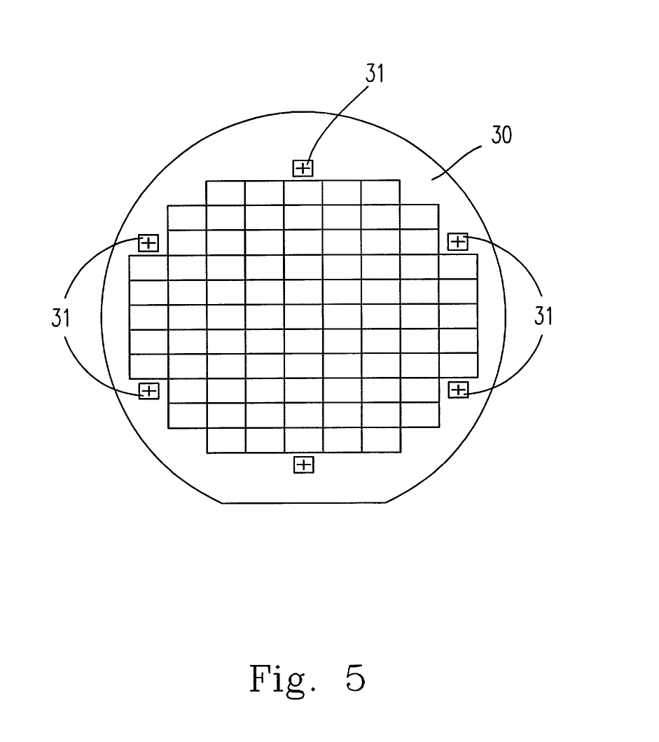

FIG. 5 is a diagram illustrating a preferred embodiment of alignment marks on a chip according to the present invention. During processing, a wafer 30 is predetermined alignment marks 31 as shown in FIG. 5. The alignment marks are used for accurately aligning in an extremely tiny error range and for obtaining a parameter during processing. Then the parameter is input into an image identification system of a processing machine, such as a fine sand spraying machine and a laser processing machine, for proceeding an image identification of the alignment marks 31 on the chip to confirm the absolute coordinates of each ink feed opening. Sequentially, the ink feed openings are formed by the processing machine. In addition, the shape of alignment mark can be circle, square, triangle, or other geometric figures.

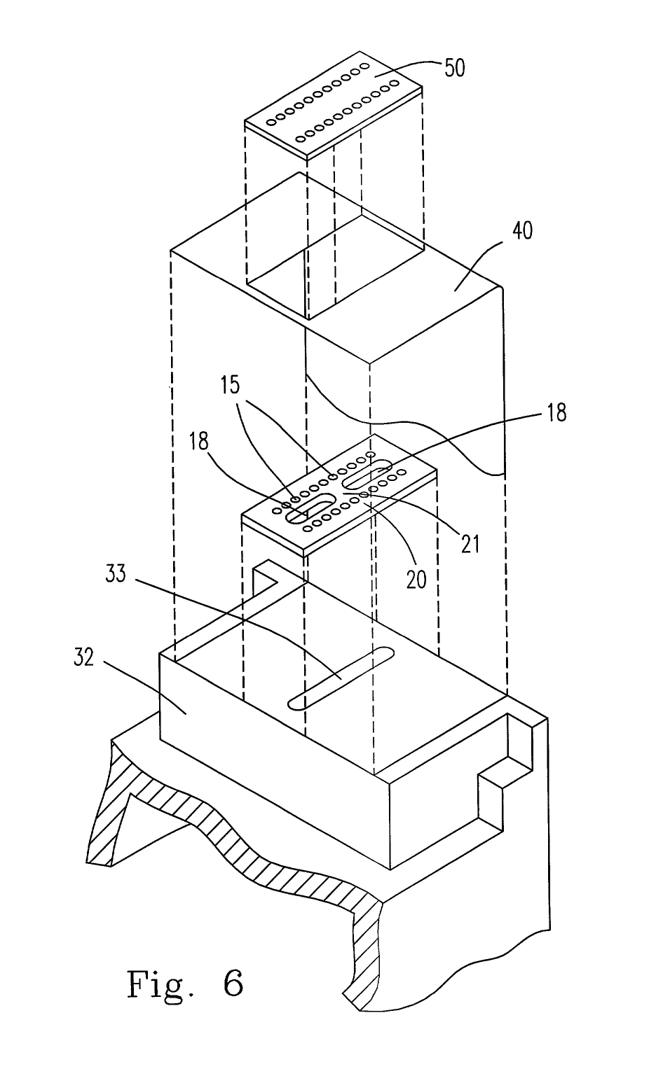

FIG. 6 is a decomposition view illustrating a preferred embodiment of a chip and a base of an ink-jet head according to the present invention. The inkjet head includes a base 32, a chip 20, a circuit board 40 and an orifice plate 50. The ink feed openings 18 of the chip 20 are corresponded to a slot 33 of the base 32, so each ink feed opening 18 is equally supplied ink from the slot 33. Further, each ink feed opening evenly supplies ink to each resistor heater element 15. In addition, because the distance between two resistor heater elements is smaller than 200 Å, the resistor heater elements 15 located at two sides of the bridge 21 can be supplied from the adjacent resistor heater elements. Therefore, it won't affect the printing quality.

In sum, the ink feed opening structure of the chip in the inkjet head according to the present invention has the advantages of increasing the strength of the chip for reducing the broken rate due to the stress during processing, and increasing the ink supplying rate. Therefore, the present invention can efficiently increase the yield and the reliability.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A chip structure in an ink-jet head comprising plural ink feed openings arranged in a longitudinal direction.

2. The chip structure according to claim 1 wherein each of said plural ink feed openings has an edge which is arc-shaped.

3. The chip structure according to claim 1 wherein said plural ink feed openings have a shape selected from a group consisting of rectangle, ellipse, elongated ellipse, and two elongated ellipses collaterally combined to each other.

4. An ink-jet head comprising:
a base including a slot for supplying an ink;
a chip including a plurality of ink feed openings arranged in a longitudinal direction and disposed on said base, wherein said plural ink feed openings of said chip are corresponded to said slot of said base for supplying said ink from said slot of said base to said plural ink feed openings of said chip;
a circuit board for connecting a resistor heater element of said chip to an external circuit; and
an orifice plate disposed on said chip.

5. The ink-jet head according to claim 4 wherein said base is a plastic body.

6. The ink-jet head according to claim 4 wherein said slot of said base has an area covering the area of said plural ink feed openings of said chip.

7. The ink-jet head according to claim 4 wherein said slot of said base has an edge which is arc-shaped.

8. The ink-jet head according to claim 4 wherein said slot of said base has a shape selected from a group consisting of rectangle, ellipse, elongated ellipse, and two elongated ellipses collaterally combined to each other.

9. A method for fabricating a plurality of ink feed openings of a chip in an ink-jet head comprising steps of:
forming an alignment mark on said chip;
inputting a parameter into an image identification system in a processing machine;
proceeding an image identification of said alignment mark on said chip according to said parameter to confirm a predetermined position of each said ink feed opening; and
forming said plural ink feed openings of said chip by mechanical processing.

10. The method according to claim 9 wherein said processing machine is one of a fine sand spraying machine and a laser processing machine.

11. The method according to claim 9 wherein said image identification system comprises an electric charge coupling device, a servo-motor and a software.
